(19) United States
(12) Patent Application Publication
(10) Pub. No.: US 2026/0149880 A1
(43) Pub. Date: May 28, 2026

(54) Method and Computing Device for Focus Region-Based Data Capture

(71) Applicant: Zebra Technologies Corporation, Lincolnshire, IL (US)

(72) Inventors: Sundaresan Sundaram, Bangalore (IN); Vikram B. Mangeshwar, Bangalore (IN); Mayuresh Mahabala, Bangalore (IN)

(21) Appl. No.: 18/958,129

(22) Filed: Nov. 25, 2024

(51) Int. Cl. H04N 23/67; G06V 30/224

(52) U.S. Cl. CPC H04N 23/67; G06V 30/224

(57) ABSTRACT

A method includes: determining a metric corresponding to variation in distances between a plurality of imaging targets and an image sensor; based on the metric, selecting a set of focus regions, each focus region having (i) a portion of a field of view of the image sensor, and (ii) a focus position within the portion; for each focus region, controlling the image sensor to capture an image using the corresponding focus position; and providing the captured images to a decoder.

### BACKGROUND

An image-based barcode scanner may capture an image depicting multiple barcodes, and attempt to decode each barcode in the image. Under some conditions, however, e.g., dependent on the distance between the scanner and the barcodes, the scanner may fail to decode certain barcodes in a given image.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a computing device for data capture

FIG. 2 is a diagram illustrating an image including a barcode affected by sub-optimal focus settings.

FIG. 3 is a flowchart of a method of focus region-based data capture.

FIG. 4 is a diagram illustrating example metrics determined at block 305 of the method of FIG. 3.

FIG. 5 is a diagram illustrating the effect of sensor orientation on imaging quality.

FIG. 6 is a diagram illustrating an example performance of block 320 of the method of FIG. 3.

FIG. 7 is a diagram illustrating another example performance of block 320 of the method of FIG. 3.

FIG. 8 is a diagram illustrating a set of images captured at block 325 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, comprising: determining a metric corresponding to variation in distances between a plurality of imaging targets and an image sensor; based on the metric, selecting a set of focus regions, each focus region having (i) a portion of a field of view of the image sensor, and (ii) a focus position within the portion; for each focus region, controlling the image sensor to capture an image using the corresponding focus position; and providing the captured images to a decoder.

Additional examples disclosed herein are directed to a computing device, comprising: an image sensor; and a processor configured to: determine a metric corresponding to variation in distances between a plurality of imaging targets and an image sensor; based on the metric, select a set of focus regions, each focus region having (i) a portion of a field of view of the image sensor, and (ii) a focus position within the portion; for each focus region, controlling the image sensor to capture an image using the corresponding focus position; and provide the captured images to a decoder.

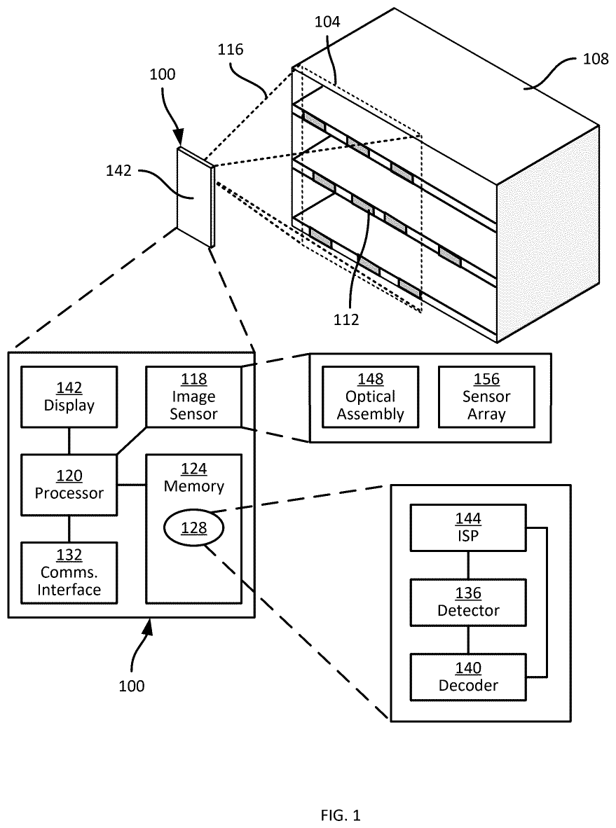

FIG. 1 illustrates a computing device 100, such as a mobile computer, a smart phone, a barcode scanner, an imaging device mounted on a chassis of an autonomous or semi-autonomous apparatus, or the like. The device 100 includes a housing supporting various components of the device 100, discussed below. The device 100 can be operated to capture images, and is configured to detect and decode certain information within such images. The information detected and decoded by the device 100 can include barcodes, e.g., indicia using one-dimensional symbologies that encode data in linear arrays (e.g., UPC-A, Code 128, and the like), as well as symbols with two-dimensional symbologies (e.g., Data Matrix, QR Code, DotCode, and the like). The information detected and decoded by the device 100 can also include other forms of machine-readable information, such as text, e.g., decoded via an optical character recognition process or the like.

For example, the device 100 can be operated to capture an image representing a region 104 of a shelf or other support structure 108 that supports one or more imaging targets 112 such as barcodes, text strings, or the like (illustrated as grey boxes in FIG. 1). In the illustrated example, the support structure 108 includes shelves, and the targets 112 are disposed on shelf edges, e.g., facing into an aisle of a facility in which the device 100 is deployed. The targets 112 can include, for example, labels disposed on the shelf edges and including either or both of barcodes and text strings. A wide variety of other objects, or collections of objects, can carry the targets 112 in other examples. For example, the targets 112 can be affixed to packages in a sorting facility, on products on the support structure 108, or the like. In other examples the targets 112 can be presented on a sheet, e.g., listing a set of items in a pallet or other aggregation of inventory. Such a sheet may therefore include a grid or list containing multiple imaging targets.

The region 104 of the support structure 108 contains nine targets 112 in the illustrated example, although it will be understood that other images captured by the device 100 may encompass larger or smaller numbers of targets 112. The targets 112 appear at various positions within the region 104 of the support structure 108. The extent of the region 104 is determined by a field of view (FOV) 116 of an image sensor 118 of the device 100. The image sensor 118 can include a two-dimensional color camera based on any suitable sensor technology (e.g., a complementary metal-oxide semiconductor or CMOS-based sensor). In other examples, the image sensor 118 can include a time-of-flight (ToF) camera or other sensor configured to capture both image (e.g., color values for each of a plurality of pixels) and depth data (e.g., distance measurements for each of the plurality of pixels).

The image sensor 118 can be supported by a housing of the device 100, along with various other components of the device 100, including a processor 120, such as a central processing unit (CPU), graphics processing unit (GPU), application-specific integrated circuit (ASIC), or the like. The processor 120 is communicatively coupled with a non-transitory computer-readable storage medium such as a memory 124, e.g., a combination of volatile memory elements (e.g., random access memory (RAM)) and non-volatile memory elements (e.g., flash memory or the like). The memory 124 stores a plurality of computer-readable instructions in the form of applications, including in the illustrated example a data capture application 128, whose execution by the processor 120 configures the device 100 to process images captured via the sensor 118 to detect and/or decode targets 112 therein.

The device 100 can also include a communications interface 132, enabling the device 100 to communicate with other computing devices (not shown) via any suitable communications links. The device 100 can also include one or more output devices, such as a display 142 (e.g., disposed on an opposite side of the device 100 from the sensor 118), a speaker (not shown), or the like. In other examples, the display 142 can be omitted, e.g., in the case of a barcode scanner with a ring form factor, implementations where the device 100 is a component of an autonomously-navigating apparatus, or the like. The device 100 can further include one or more input devices, such as a microphone, a touch screen (e.g., integrated with the display 142), a keypad, a scan trigger, or the like.

The device 100 implements, for example via the application 128, a detector 136 configured to process images captured via the sensor 118 to detect regions of interest therein containing the targets 112, and a decoder 140 configured to process the regions of interest from the detector 136 to decode barcodes, recognize text strings, or the like. The device 100 also implements an imaging controller, also referred to as an image signal processor (ISP) 144. The ISP 144 is shown as being implemented via the application 128, but in some embodiments can be implemented as a dedicated hardware controller integrated with the image sensor 118, the processor 120, or the like. The detector 136 and the decoder 140 can also be implemented via dedicated hardware rather than by the application 128 in other examples, such as a scan engine.

The ISP 144 is configured to control components of the image sensor 118 to capture images for further processing (e.g., by the detector 136 and the decoder 140). The components of the image sensor 118 controlled by the ISP 144 can include, as shown in FIG. 1, an optical assembly 148 having one or more lenses. The lens or lenses of the optical assembly 148 can be movable, e.g., under the control of the ISP 144, to alter the distance from the sensor 118 at which objects in the FOV 116 are in focus, to alter magnification applied to the FOV 116, and the like. The image sensor 118 can also include a sensor array 156, e.g., including a plurality of photodiodes (e.g., defining from several hundred thousand to millions of pixels, with the total number depending on the resolution of the image sensor 118). The ISP 144 can be configured to implement an autofocus (AF) function, e.g., by comparing data from a plurality of phase detection elements of the image sensor 118, or other suitable hardware elements, and controlling the optical assembly 148 to place at least a portion of the FOV 116 in focus.

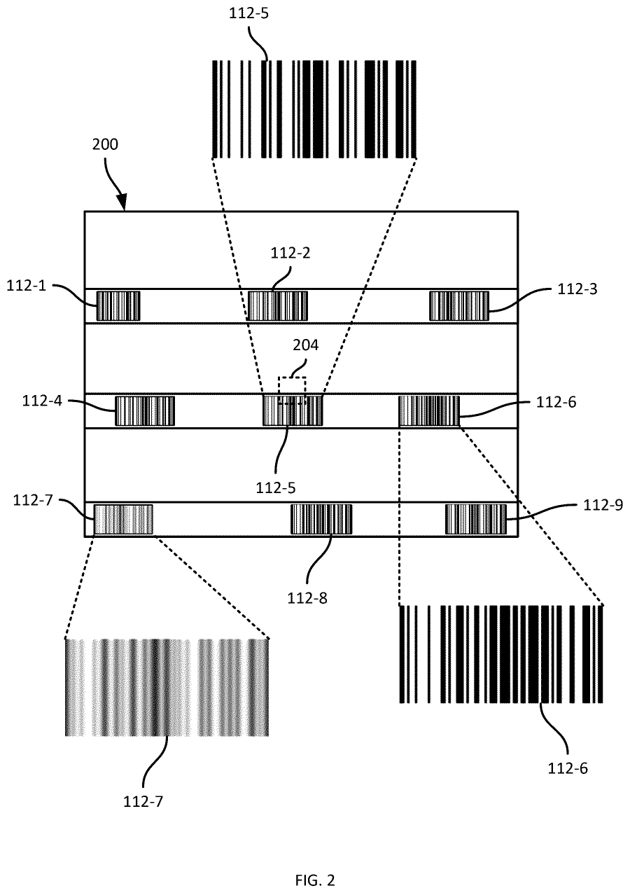

Referring to FIG. 2, an example image 200 captured by the sensor 118 and depicting the region 104 of the support structure 108 is illustrated. The image 200 contains the targets 112 mentioned in connection with FIG. 1, which in this example are barcodes and are therefore referred to individually in FIG. 2 as barcodes 112-1, 112-2, 112-3, 112-4, 112-5, 112-6, 112-7, 112-8, and 112-9 (collectively, the barcodes 112, and generically, a barcode 112; similar nomenclature may be used herein for other components whose reference numbers include hyphenated suffixes).

The image 200 is captured using the autofocus function implemented by the ISP 144, e.g., based on phase detection elements as noted above. For example, the image sensor 118 can include a plurality of phase detection elements distributed throughout the array 156, and can be configured, for each image capture, to determine a lens position to apply to the optical assembly 148 for use in capturing the image. To capture the image 200, for example, the ISP 144 can be configured to set a position of the lens assembly to place a central region 204 of the image 200 in focus. However, certain areas of the image 200, such as the area containing the barcode 112-7, may appear out of focus and therefore blurry, as shown in FIG. 2, in contrast to the barcodes 112-5 and 112-6, which are in focus.

Which objects in the FOV 116 appear out of focus may depend in part on the depth of field (DoF) achievable by the image sensor 118, which is in turn dependent on the distance between the sensor 118 and the targets 112. Although DoF may be effectively infinite when the image sensor 118 is far from the targets 112 (e.g., more than about four meters away), at such a distance, the targets 112 may not be decodable even if they are in focus, due to their small size. The device 100 may be operated to capture images such as the image 200 from a distance of about a meter, for example, to provide large enough depictions of the targets 112. At such capture distances, though, the DoF achievable by the sensor 118 may be about 50 cm or less. As a result, variability in the distances between targets 112 and the sensor 118 may lead to some targets being out of focus. Such variability can be caused by an angle between the sensor 118 and the front of the support structure 108 (e.g., the plane containing the targets 112). Such variability can also be caused by uneven positioning of the targets 112 on the support structure 108, e.g., on items at various depths on the shelf, instead of on a plane defined by shelf edges.

With sufficient variability in the distances between the targets 112 and the sensor 118, the DoF achievable by the sensor 118 may be insufficient to encompass all the targets 112, and some targets 112 may be out of focus in a given image. Decoding of those targets 112 may therefore fail.

When decoding fails for one or more of the targets 112, the device 100 may be controlled (e.g., by an operator of the device 100 or the like) to capture additional images, and repeat attempts to detect and decode the barcodes 112. However, repeated decode attempts may also fail, as certain barcodes 112 may remain out of focus. The capture and processing of at least some of the additional images may therefore be an inefficient deployment of computational resources at the device, yielding little or no results beyond the partial decode results from the image 200.

As discussed below, the device 100 is configured, e.g., via certain functions implemented by the ISP 144, to implement dynamic region-based AF control to capture a set of images before invoking the decoder 140. The functionality implemented by the ISP 144 may reduce the number of capture attempts involved in successfully decoding the targets 112.

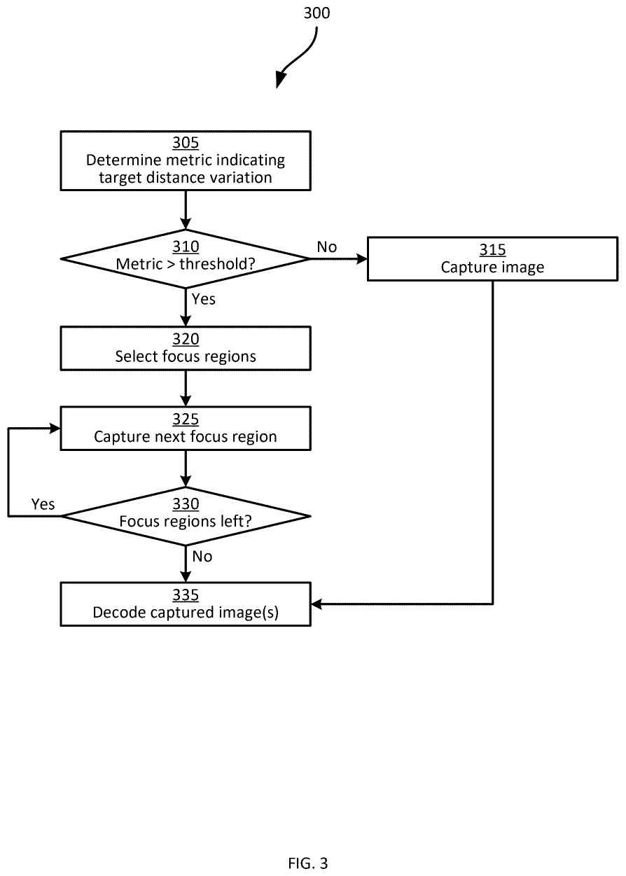

Turning to FIG. 3, a method 300 of region-based AF control for image-based barcode decoding is illustrated. The method 300 is described below in conjunction with its performance at the device 100, e.g., via execution of the application 128 by the processor 120, and/or by equivalent dedicated hardware elements as noted earlier.

At block 305, the device 100 is configured to determine a metric indicating a degree of variation in distances between the sensor 118 and the targets 112. As noted above, the targets 112 within the FOV 116 may be at various depths relative to the image sensor 118, e.g., due to an orientation of the device 100 relative to the support structure 108, and/or due to the physical attributes of the support structure 108. For example, the support structure 108 can include a pegboard alongside the shelves shown in FIG. 1, and thus labels affixed to the pegboard may be at a different depth compared to the labels affixed to the shelf edges. In such cases, even if the device 100 is oriented to place the sensor plane of the image sensor 118 substantially parallel with the shelf edges, the targets 112 on the pegboard may be further from (or closer to) the image sensor 118 than the targets 112 on the shelf edges. In further examples, the device 100 may be placed at an angle relative to the support structure 108, such that the sensor image of the image sensor 118 is not parallel to the plane formed by the shelf edges. Certain targets 112 on the shelf edges will therefore be further from the image sensor 118 than others.

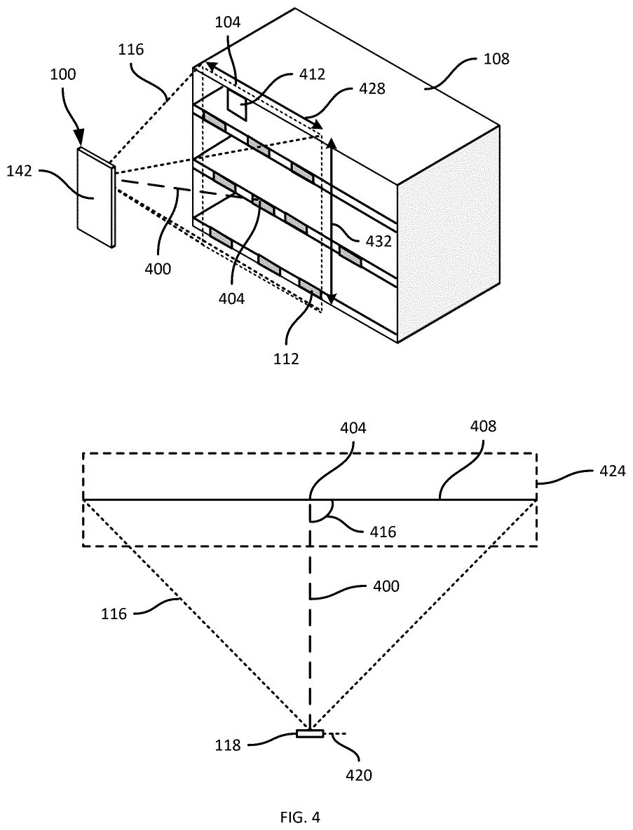

Block 305 may be performed before object detection is performed by the device 100, and the positions of the targets 112 within the FOV 116 may therefore not be available. Thus, even if the device 100 includes a depth sensor such as a ToF camera, depths associated with each target 112 may not be available. The metric determined at block 305 can therefore be used as a proxy for per-target depths. For example, the metric determined at block 305 can include a distance from the image sensor 118 to the support structure 108 or other object in the FOV 116. FIG. 4 illustrates an example metric in the form of a distance 400 from the image sensor 118 to a center 404 of the FOV 116. The distance 400 can be obtained, for example, from a range finder or other depth sensor of the device 100. The depth sensor can be a separate sensor from the image sensor 118, or can be integrated with the image sensor 118 (e.g., the image sensor 118 can include a ToF camera configured to obtain the depth 400).

In further examples, the metric determined at block 305 can include an orientation of the image sensor 118 relative to a target plane 408 (shown in the overhead view in the lower portion of FIG. 4) in the FOV 116. The target plane 408 can be a plane defined by the shelf edges of the support structure, for example. The device 100 can be configured to detect the target plane 408 by, for example, capturing a depth map (e.g., via a ToF camera or the like) and performing a plane detection operation, e.g., based on a random sample consensus (RANSAC) fitting technique or the like. In other examples, the device 100 can be configured to capture an initial image of the FOV 116, and detect a fiducial marker 412, such as an ArUco marker, in the initial image.

Based on the marker 412 as shown in the image, the device 100 can be configured to determine a pose of the image sensor 118 (and, by extension, a pose of the device 100 itself) relative to the marker 412. As shown in FIG. 4, the marker 412 is disposed in the same plane as the targets 112 (e.g., the target plane 408), and by the device 100 can therefore detect the target plane 408 by detecting the marker 412. The dimensions of the marker 412 and visual features on the marker 412 may be available to the device 100, e.g., stored in the memory 124 or encoded in the marker 412. Based on those dimensions, the device 100 can determine the distance 400 to the target plane 408, as well as an angle 416 between the distance 400 and the target plane 408. The angle 416, as will be apparent, is perpendicular to a sensor plane 420 of the image sensor 118 in this example. From the angle 416, the device 100 can therefore determine an angle between the sensor plane 420 and the target plane 408. In some examples, the device 100 can determine two angles between the sensor plane 420 and the target plane 420, e.g., a pitch angle and a yaw angle.

FIG. 4 also illustrates a depth of field 424, which is a zone extending towards the sensor 118 and away from the sensor 118 by a given distance (e.g., the same distance in either direction) from an image plane (that is, a plane on which the image sensor 118 is focused). In the example of FIG. 4, the image plane coincides with the target plane 408. As will be apparent, if the sensor plane 420 is not parallel to the target plane 408, the image plane (and therefore the depth of field zone 424) will not be parallel to the target plane 408, and the zone 424 may not fully contain the target plane 408. In such cases, some targets 112 may fall outside the zone 424, and thus may not be in focus in an image captured by the image sensor 118 and focused at or near the center 404.

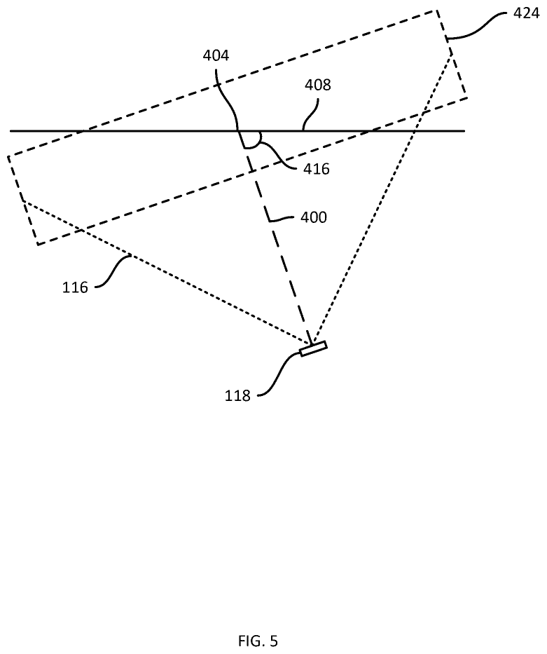

Referring to FIG. 5, the overhead view of FIG. 4 is illustrated, with the image sensor 118 at a different orientation relative to the target plane 408. Specifically, the angle 416 is smaller than 90 degrees in FIG. 5 (e.g., about 80 degrees in this example), and the sensor plane 420 is therefore at an angle of about 10 degrees relative to the target plane 408. The DoF 424 still encompasses some of the target plane 408, and certain targets 112 (e.g., the targets 112-2, 112-5, and 112-8 shown in FIG. 2) may therefore still be in focus. Other targets 112, e.g., near the ends of the target plane 408, may be out of focus, however.

In further examples, the metric determined at block 305 can include one or more dimensions of the support structure 108, e.g., a width 428 and/or a height 432 of the portion of the support structure within the FOV 116. The width 428 and the height 432 can be determined, for example, with reference to the marker 412. For example, based on a given dimension of the marker 412 (or a visual feature on the marker 412) in pixels from an initial image captured by the sensor 118, and on a known physical dimension of the marker 412, the device 100 can determine the physical dimensions of the support structure 108 from the dimensions of the support structure 108 in pixels.

Returning to FIG. 3, at block 310 the device 100 is configured to determine whether the metric(s) from block 305 meet or exceed a threshold. For example, the device 100 can be configured to determine whether the distance 400 meets or exceeds a threshold distance, e.g., predefined and stored in the memory 124. In further examples, the device 100 can determine whether an angle between the sensor plane 420 and the target plane 408 meets or exceeds a threshold angle. In still further examples, the device 100 can determine whether a dimension (e.g., the width 428, the height 432, and/or an area derived therefrom) of the support structure 108 within the FOV 116 meets or exceeds a threshold dimension.

When more than one metric is determined at block 305, e.g., the distance 400 and one or more angles (e.g., pitch and yaw angles) between the sensor plane 420 and the target plane 408, the determination at block 310 can include determining whether each metric meets or exceeds a corresponding threshold. For example, if at least one of the metrics meets or exceeds a threshold, the determination at block 310 may be affirmative. The determination at block 310 may be negative when every metric does not meet the corresponding threshold.

A wide variety of thresholds may be used at block 310. For example, the determination at block 310 may be affirmative if an angle between the sensor plane 420 and the target plane 408 exceeds five degrees. The determination at block 310 may also be affirmative if the distance 400 exceeds one meter, for example.

As will be apparent, when the metric(s) from block 305 exceed the threshold(s) at block 310, at least some targets 112 are likely to be outside the DoF currently achievable by the sensor 118. Those targets 112 may therefore be out of focus in images captured by the sensor 118, e.g., using the central region 204 for autofocus control. When the metric(s) from block 305 do not exceed the threshold(s) at block 310, the targets 112 are likely to appear in focus in a single image. When the determination at block 310 is negative, the device 100 proceeds to block 315. At block 315, the device 100 is configured to capture an image, e.g., using the central region 204 for autofocus control.

When the determination at block 310 is affirmative, the device 100 is configured to select a set of focus regions at block 320, based on the metric(s) from block 305. The focus regions selected at block 320 subdivide the FOV 116, such that each focus region includes a portion of the FOV 116. Further, each focus region includes a focus position within the portion.

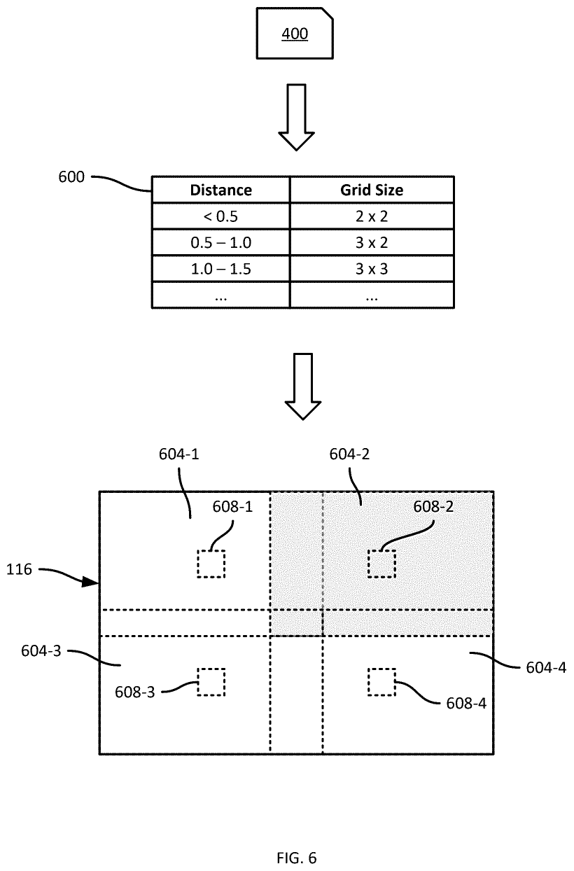

To select the set of focus regions at block 320, the device 100 can maintain configuration data, e.g., in the memory 124, defining a plurality of sets of focus regions. Turning to FIG. 6, for example, configuration data 600 is shown mapping each of a plurality of threshold distances 400 to a focus region configuration (“grid size”). For example, when the distance 400 is below 0.5 meters, the device 100 is configured to generate a 2×2 grid of focus regions. When the distance 400 is between 0.5 and 1.0 meters, the device 100 is configured to generate a 3×2 grid of focus regions, and so on. The example thresholds shown in FIG. 6 are solely illustrative, and a wide variety of other distance thresholds and grid sizes can be specified. In other examples, the configuration data can define sets of focus regions corresponding to support structure dimensions (e.g., with thresholds corresponding to areas of support structure). In further examples, the configuration data can define sets of focus regions corresponding to angles of orientation between the image sensor 118 and the target plane 408. When the device 100 stores configuration data defining sets of focus regions (e.g., in the form of grid configurations as shown in FIG. 6) for each of two or more metrics, the metrics can be prioritized. For example, the device 100 can be configured to select a set of focus regions based on angle of orientation, if available, and to select a set of focus regions based on the distance 400 if the angle is not available.

FIG. 6 illustrates a set of focus regions 604-1, 604-2, 604-3, and 604-4 selected at block 320, e.g., when the distance 400 is below 50 cm. Each region 604 has pixel dimensions determined by dividing the total area of the FOV 116 in pixels into the number of regions specified in the selected mapping from the configuration data 600 (e.g., four regions, in this example). The focus region 604-2 is highlighted to illustrate the dimensions of each region 604. For example, the device 100 can divide the total width of the FOV 116 by two, and the total height of the FOV 116 by two. Each focus region 604 has the resulting width and height. In some examples, as shown in FIG. 6, each focus region 604 can be padded with a predetermined height and/or width in pixels, such that the focus regions 604 overlap. Each focus region includes a respective focus position 608-1, 608-2, 608-3, and 608-4. As discussed below, the focus positions 608 are used to control the AF function of the sensor 118 while capturing images.

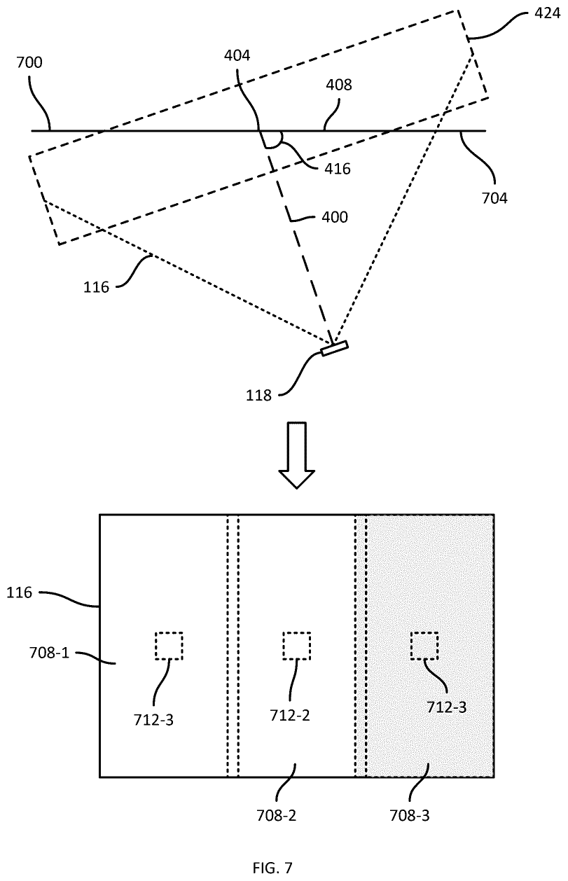

Turning to FIG. 7, in some examples, the device 100 can determine the set of focus regions dynamically. For example, when the metric from block 305 includes an angle of orientation that exceeds the threshold at block 310 (e.g., a yaw angle as shown in the overhead view of FIG. 7), the device 100 can be configured to determine the extent of the DoF 424, based on the distance 400 and sensor parameters such as the aperture of the image sensor 118, focal length, and the like. The device 100 can further be configured to determine whether any portion of the target plane 408 falls outside the DoF 424, e.g., the portions 700 and 704. The device 100 can be configured to dynamically select focus regions based on the portions of the target plane 408 outside the DoF 424. In the example of FIG. 7, where there is a yaw angle between the image sensor 118 and the target plane but no pitch angle, the device 100 may generate focus regions 708-1, 708-2, and 708-3, with respective focus positions 712-1, 712-2, and 712-3.

Returning to FIG. 3, at block 325, the device 100 is configured to initiate a sequence of image capture operations. The device 100 captures an image for each focus region in the set from block 320. In other words, the sequence of images to be captured is predefined from the set selected at block 320, and is therefore not dependent on decode results for any individual image. The device 100 need not initiate decoding of any individual image until after the sequence of images has been captured.

For example, at block 325 the device 100 can capture an image according to the focus region 604-1. The device 100 can capture an image using the focus position 608-1 instead of the focus position shown in FIG. 2 (the central region 204). Further, the device 100 can capture an image including the entire FOV 116, and crop out the portion of the captured image that lies outside the focus region 604-1. At block 330, the device 100 is configured to determine whether focus regions remain to be captured. The device 100 is configured to repeat block 325 when the determination at block 330 is affirmative, until an image has been captured for each focus region 604. Because the device 100 need not perform any decoding operations in between image captures, the set of images captured via performances of block 325 can be captured quickly (e.g., in less than 100 ms).

When the determination at block 330 is negative, the device 100 proceeds to block 335. At block 335, the images captured at block 325 can be provided to the decoder 140 for detecting and decoding text strings, barcodes, and the like. The images can also be transmitted to another computing device for decoding in some examples.

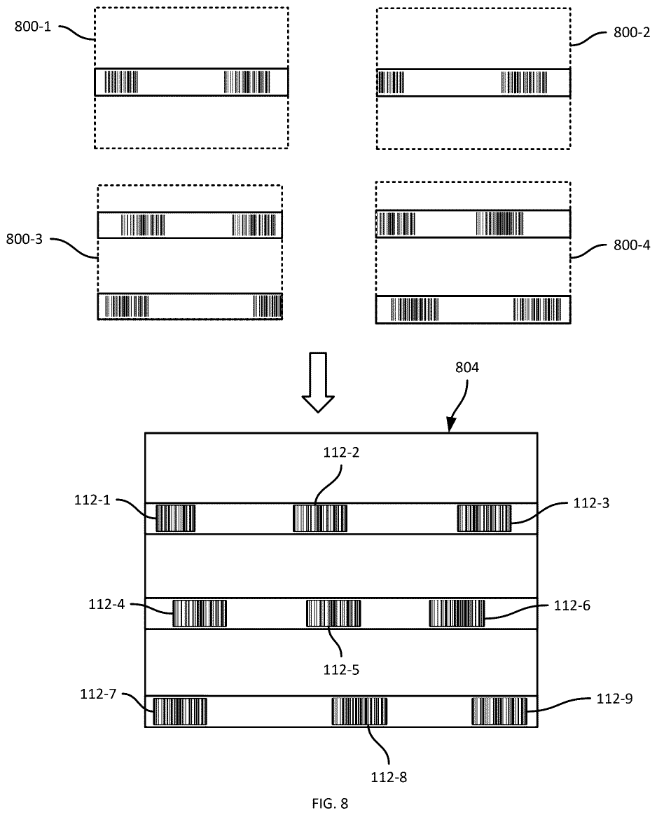

Turning to FIG. 8, four images 800-1, 800-2, 800-3, and 800-4 (e.g., cropped from full frames, to the dimensions of the respective focus regions 604) are shown. The device 100 can be configured to decode each image 800 separately, or to merge the images 800 into a combined image 804 covering the full FOV 116 before decoding. As will be apparent from FIG. 8, merging the images 800 may reduce the risk of a barcode being split between images 800 and decoding failing for such a barcode.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
determining a metric corresponding to variation in distances between a plurality of imaging targets and an image sensor;
based on the metric, selecting a set of focus regions, each focus region having (i) a portion of a field of view of the image sensor, and (ii) a focus position within the portion;
for each focus region, controlling the image sensor to capture an image using the corresponding focus position; and
providing the captured images to a decoder.

2. The method of claim 1, wherein the imaging targets include at least one of barcodes or text strings.

3. The method of claim 1, wherein determining the metric comprises: determining a distance from the image sensor to a first point in a field of view of the image sensor.

4. The method of claim 3, wherein determining the distance comprises:
obtaining the distance via a depth sensor.

5. The method of claim 1, wherein determining the metric comprises: determining an angle between a sensor plane of the image sensor and a plane containing at least a portion of the imaging targets.

6. The method of claim 5, wherein determining the angle comprises:
capturing an initial image;
detecting a pose estimation marker in the initial image; and
determining the angle based on the pose estimation marker.

7. The method of claim 1, further comprising:
prior to selecting the set of focus regions, determining that the metric exceeds a threshold.

8. The method of claim 1, wherein capturing an image for each focus region comprises:
capturing an image of the field of view; and
cropping the image to the corresponding portion of the field of view.

9. The method of claim 1, wherein selecting the set of focus regions comprises:
comparing the metric to a threshold;
selecting a first set of focus regions when the metric meets the threshold; and
selecting a second set of focus regions when the metric does not meet the threshold.

10. The method of claim 1, wherein selecting the set of focus regions comprises:
determining a depth of field of the image sensor;
determining a plane corresponding to the imaging targets; and
identifying portions of the plane outside the depth of field.

11. A computing device, comprising:
an image sensor; and
a processor configured to:
determine a metric corresponding to variation in distances between a plurality of imaging targets and an image sensor;
based on the metric, select a set of focus regions, each focus region having (i) a portion of a field of view of the image sensor, and (ii) a focus position within the portion;
for each focus region, controlling the image sensor to capture an image using the corresponding focus position; and
provide the captured images to a decoder.

12. The computing device of claim 11, wherein the imaging targets include at least one of barcodes or text strings.

13. The computing device of claim 11, wherein the processor is configured to determine the metric by:
determining a distance from the image sensor to a first point in a field of view of the image sensor.

14. The computing device of claim 13, wherein the processor is configured to determine the distance by:
obtaining the distance via a depth sensor.

15. The computing device of claim 11, wherein the processor is configured to determine the metric by: determining an angle between a sensor plane of the image sensor and a plane containing at least a portion of the imaging targets.

16. The computing device of claim 15, wherein the processor is configured to determine the angle by:
capturing an initial image;
detecting a pose estimation marker in the initial image; and
determining the angle based on the pose estimation marker.

17. The computing device of claim 11, wherein the processor is configured to:
prior to selecting the set of focus regions, determining that the metric exceeds a threshold.

18. The computing device of claim 11, wherein the processor is configured to capture an image for each focus region by:
capturing an image of the field of view; and
cropping the image to the corresponding portion of the field of view.

19. The computing device of claim 11, wherein the processor is configured to select the set of focus regions by:
comparing the metric to a threshold;
selecting a first set of focus regions when the metric meets the threshold; and
selecting a second set of focus regions when the metric does not meet the threshold.

20. The computing device of claim 11, wherein the processor is configured to selecting the set of focus regions by:
determining a depth of field of the image sensor;
determining a plane corresponding to the imaging targets; and
identifying portions of the plane outside the depth of field.
